(19) United States
(12) Patent Application Publication
(10) Pub. No.: US 2026/0057811 A1
(43) Pub. Date: Feb. 26, 2026

(54) Handicap Parking Spot Authorization System

(71) Applicant: Anthony Joseph Wassil, Clifton Park, NY (US)

(72) Inventor: Anthony Joseph Wassil, Clifton Park, NY (US)

(21) Appl. No.: 19/310,564

(22) Filed: Aug. 26, 2025

Related U.S. Application Data
(60) Provisional application No. 63/687,108, filed on Aug. 26, 2024.

(51) Int. Cl. G09F 13/02; G06F 21/32; G08G 1/14

(52) U.S. Cl. CPC G09F 13/02; G06F 21/32; G08G 1/149

(57) ABSTRACT

The handicap parking spot authorization system ensures only handicapped individuals are parking in handicap spots. The system alerts law enforcement when an individual parks in a handicap spot that is not supposed to be there. In order to accomplish this the system has a base that is positioned adjacent to a handicap parking spot. Further, system has lights that indicates whether the individual in the parking spot is supposed to be there or not. Additionally, the infrared sensor detects the user in the parking spot. Further, the solar panel provides the system with electricity. Furthermore, the mobile device allows the user to authenticate their handicap status with the computing system. Thus, the system authorizes vehicles parked in handicap spots to ensure that only handicap individuals park within these handicap spots.

### FIELD OF THE INVENTION

The present invention relates generally to a system that deters individuals from parking in handicap parking spots. More specifically, the present invention is a system that authenticates users to ensure they have the proper credentials to park in a handicap spot.

### BACKGROUND OF THE INVENTION

Unauthorized parking in handicap spots is a significant issue that affects individuals who genuinely need these designated spaces. These spots are reserved for people with disabilities, providing them with convenient access to buildings and facilities. When unauthorized individuals park in these spaces, it not only violates the law but also creates unnecessary obstacles for those who rely on them for mobility. The misuse of handicap parking spots can result in fines, towing, and other penalties, but more importantly, it shows a lack of respect and consideration for the needs of others. Public awareness and stricter enforcement of parking regulations are essential in addressing this problem and ensuring that handicap spots remain available for those who truly need them.

An objective of the present invention is to provide users with a system that detects unauthorized vehicles in handicap parking spots, wherein the system then alerts law enforcement to remove the unauthorized vehicle. The present invention intends to provide users with a system that verifies a user's handicap status ignoring potentially fake handicap signs usually displayed on the rear-view mirror. In order to accomplish that, a preferred embodiment of the present invention comprises a base, a plurality of lights, an infrared sensor, a solar panel, and a mobile device. Thus, the present invention is a system that authorizes vehicles parked in handicap spots to ensure that only handicap individuals park within these handicap spots.

### BRIEF DESCRIPTION OF THE DRAWINGS

FIG. 1 is an illustration of the present invention.

FIG. 2 is a block diagram of the system of the present invention.

FIG. 3 is a top front right perspective view of the present invention.

FIG. 4 is a bottom rear left perspective view of the present invention.

FIG. 5 is a front view of the present invention.

FIG. 6 is a right-side view of the present invention.

FIG. 7 is a top perspective view of the present invention.

FIG. 8 is a block diagram of the present invention.

### DETAILED DESCRIPTION OF THE INVENTION

All illustrations of the drawings are for the purpose of describing selected versions of the present invention and are not intended to limit the scope of the present invention.

The present invention is a system that ensures only handicap individuals are parking in handicap spots. The present invention seeks to provide users with a system that alerts law enforcement when an individual parks in a handicap spot that is not supposed to be there. In order to accomplish this the present invention comprises a base that is positioned adjacent to a handicap parking spot. Further, the plurality of lights indicates whether the individual in the parking spot is supposed to be there or not. Additionally, the infrared sensor detects the user in the parking spot. Further, the solar panel provides the present invention with electricity. Furthermore, the mobile device allows the user to authenticate their handicap status with the computing system. Thus, the present invention is a system that authorizes vehicles parked in handicap spots to ensure that only handicap individuals park within these handicap spots.

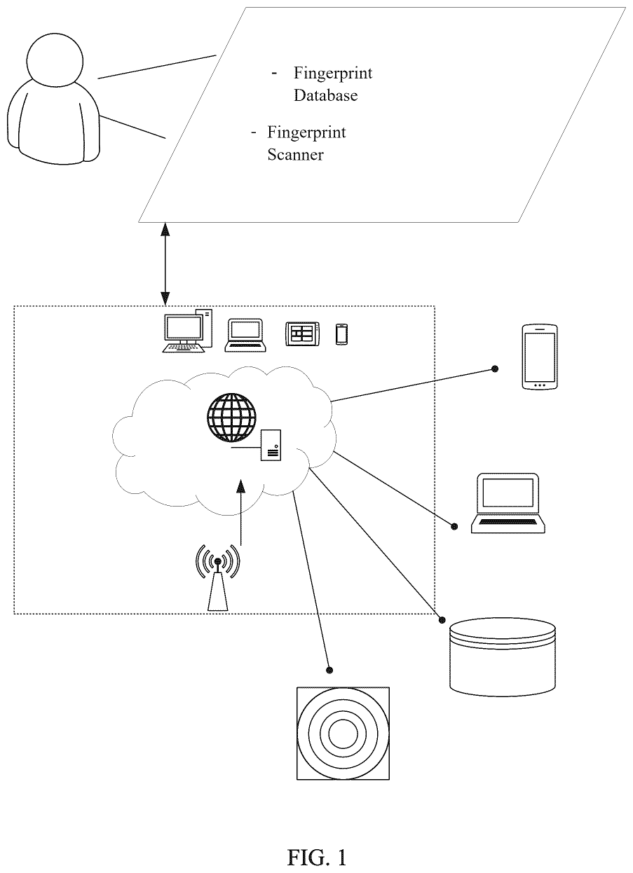

FIG. 1 is an illustration of an online platform consistent with various embodiments of the present disclosure. By way of non-limiting example, the online platform to enable authorization of users parking in handicap spots may be hosted on a centralized server, such as, for example, a cloud computing service. The centralized server may communicate with other network entities, such as, for example, a mobile device (such as a smartphone, a laptop, a tablet computer etc.), other electronic devices (such as desktop computers, server computers etc.), databases, and sensors over a communication network, such as, but not limited to, the Internet. Further, users of the online platform may include relevant parties such as, but not limited to, end-users, administrators, service providers, service consumers and so on. Accordingly, in some instances, electronic devices operated by the one or more relevant parties may be in communication with the platform.

A user, such as the one or more relevant parties, may access online platform through a web based software application or browser. The web based software application may be embodied as, for example, but not be limited to, a website, a web application, a desktop application, and a mobile application compatible with a computing device.

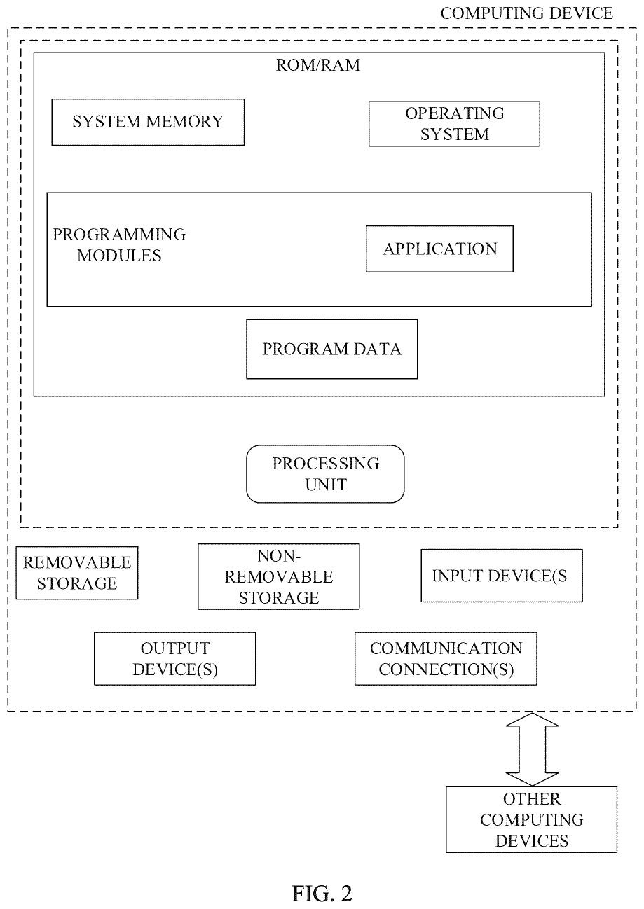

With reference to FIG. 2, a system consistent with an embodiment of the disclosure may include a computing device or cloud service, such as computing device. In a basic configuration, computing device may include at least one processing unit and a system memory. Depending on the configuration and type of computing device, system memory may comprise, but is not limited to, volatile (e.g. random-access memory (RAM)), non-volatile (e.g. read-only memory (ROM)), flash memory, or any combination. System memory may include operating system, one or more programming modules, and may include a program data. Operating system, for example, may be suitable for controlling computing device operation. In one embodiment, programming modules may include image-processing module, machine learning module. Furthermore, embodiments of the disclosure may be practiced in conjunction with a graphics library, other operating systems, or any other application program and is not limited to any particular application or system. This basic configuration is illustrated in FIG. 2 by those components within a dashed line.

Computing device may have additional features or functionality. For example, computing device may also include additional data storage devices (removable and/or non-removable) such as, for example, magnetic disks, optical disks, or tape. Such additional storage is illustrated in FIG. 2 by a removable storage and a non-removable storage. Computer storage media may include volatile and non-volatile, removable and non-removable media implemented in any method or technology for storage of information, such as computer-readable instructions, data structures, program modules, or other data. System memory, removable storage, and non-removable storage are all computer storage media examples (i.e., memory storage.) Computer storage media may include, but is not limited to, RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store information and which can be accessed by computing device. Any such computer storage media may be part of device. Computing device may also have input device(s) such as a keyboard, a mouse, a pen, a sound input device, a touch input device, a location sensor, a camera, a biometric sensor, etc. Output device(s) such as a display, speakers, a printer, etc. may also be included. The aforementioned devices are examples and others may be used.

Computing device may also contain a communication connection that may allow device to communicate with other computing devices, such as over a network in a distributed computing environment, for example, an intranet or the Internet. Communication connection is one example of communication media. Communication media may typically be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media. The term computer readable media as used herein may include both storage media and communication media.

As stated above, a number of program modules and data files may be stored in system memory, including operating system. While executing on processing unit, programming modules (e.g., application such as a media player) may perform processes including, for example, one or more stages of methods, algorithms, systems, applications, servers, databases as described above. The aforementioned process is an example, and processing unit may perform other processes. Other programming modules that may be used in accordance with embodiments of the present disclosure may include machine learning applications.

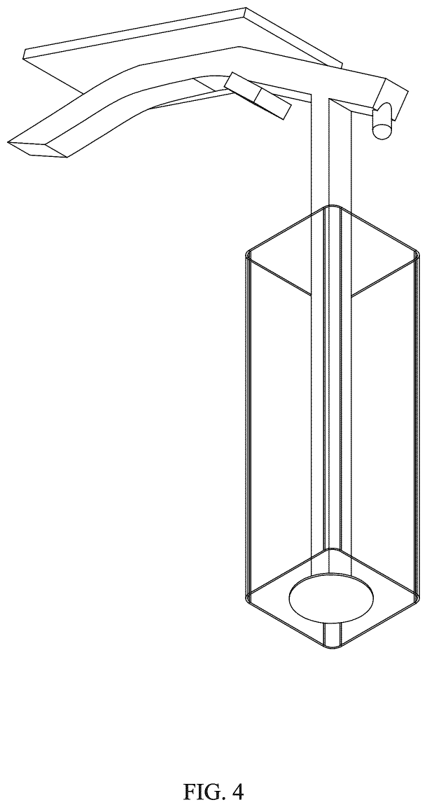

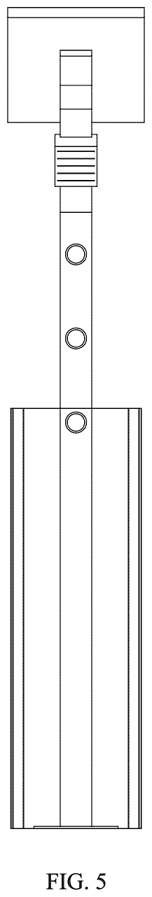

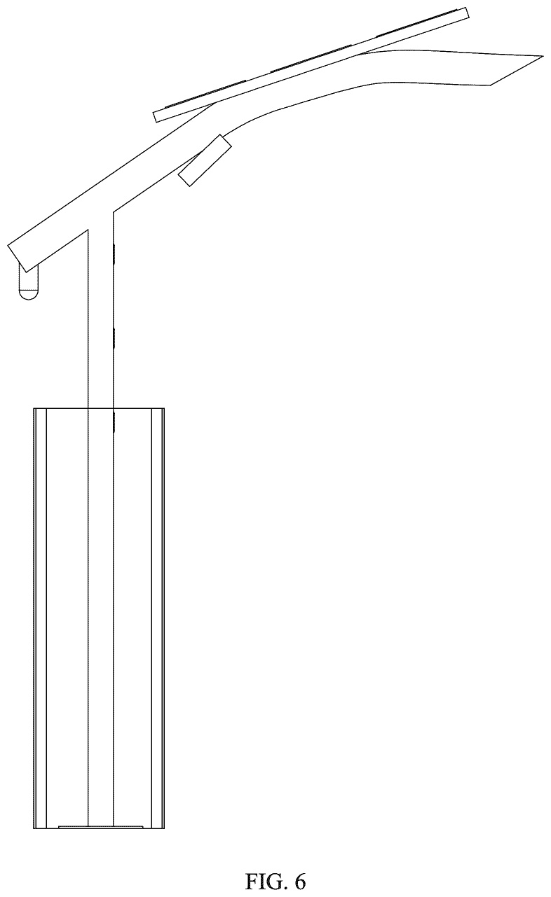

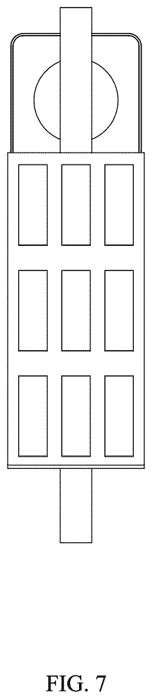

As shown in FIG. 1-8, the present invention is a system that prevents unauthorized parking in handicap spots. An objective of the present invention is to provide users with a device that communicates with the user's mobile device to authorize each user as they park. To accomplish this the present invention comprises a base, a plurality of lights, an infrared sensor, a solar panel, and a mobile device. Many of these components allow for the user to authenticate their vehicle if they are authorized to park within a handicap spot. The plurality of lights is integrated along the top side of the base. The infrared sensor is secured along the upper portion of the base. The solar panel is positioned along the top upper side of the base. The mobile device remotely communicates with the base. Thus, the present invention is a system that authorizes vehicles parked in handicap spots to ensure that only handicap individuals park within these handicap spots.

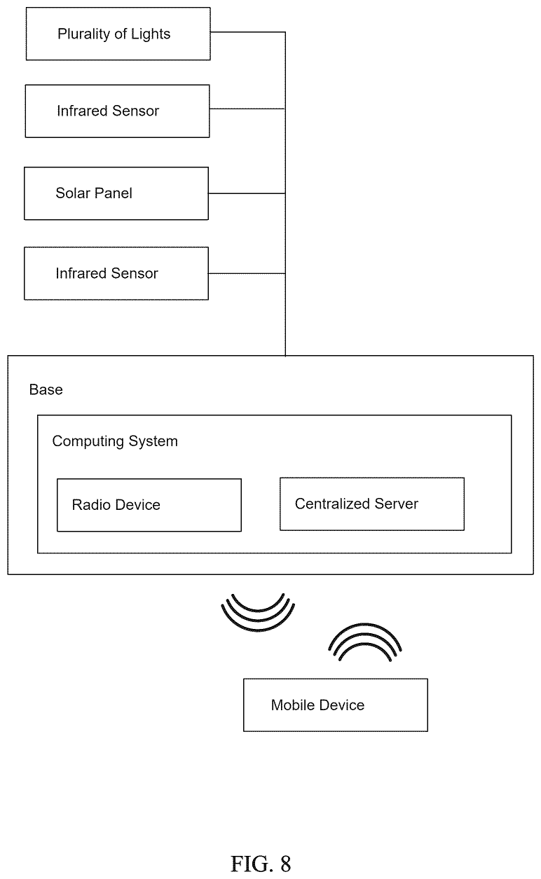

The present invention authorizes if an individual parking in a spot is supposed to park in a handicap spot. The base is designed with a steel material that arcs over a handicap spot. In its preferred embodiment the base comprises a computing system and a protective housing. The protective housing is a transparent structure that encompasses the base with a rectangular shape to prevent vandalism and damage. The protective housing further slopes above the base to prevent snow build up. The computing system is integrated within the base and is responsible for authenticating each individual that parks within the adjacent handicap spot. The computing system further comprises a radio device and a centralized server as shown in FIG. 8. The radio device allows for remote communication between the computing system and the mobile device. The centralized server hosts the information received by the mobile device. The centralized server further comprises a finger-print database. The finger-print database is utilized by the computing system to cross-check the fingerprint received from the mobile device to ensure the fingerprint received matches a fingerprint within the fingerprint database, ensuring that the individual parked in the handicap spot is supposed to be there. It should be further noted that the base can be created in many various shapes and sizes and the protective housing can be structured in various ways while still staying within the scope of the present invention.

The plurality of lights is electronically coupled to the computing system as seen in FIG. 8. The plurality of lights comprises a red, amber and green light. The green light illuminates when the allowed handicap person is parked within the spot. The amber light illuminates when there is an available spot below for a handicap person. The red light illuminates when there is a violation of the handicap law pertaining to the right to park. The plurality of lights are in constant communication with the computing system to ensure the lights illuminate accordingly.

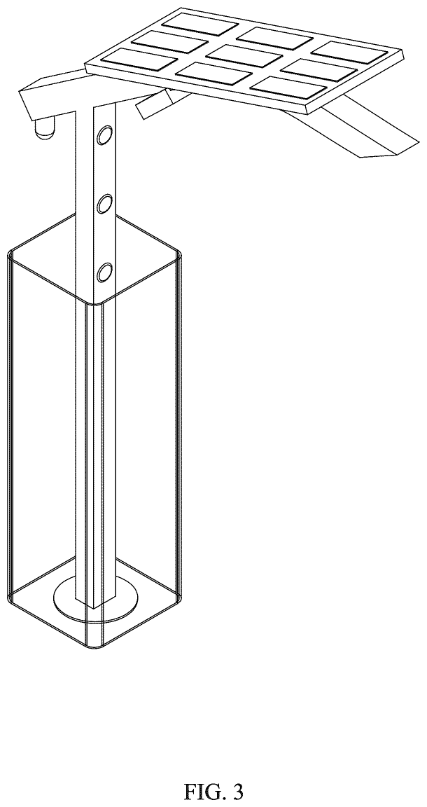

The infrared sensor is integrated along the upper portion of the base and is electronically coupled to the computing system. The infrared sensor sends a signal to the computing system when a vehicle has pulled into the spot. Once the signal is sent, a timer begins for a predetermined amount of time such as two minutes. Within the two minutes the driver needs to indicate to the computing system that they have a right to park there by authenticating their handicap status with the mobile device. As shown in FIG. 3, the solar panel is positioned along the top side of the base in an orientation to receive solar light, thus creating electrical power for the various systems within the present invention. Further, the present invention may comprise a video camera. The video camera rotates 360 degrees to ensure each spot directly around the base is visible. This allows a remote user to monitor the area around the base to identify any individual who might attempt to destroy or vandalize the unit. The video camera may further comprise facial recognition technology such as a facial recognition module. This enables the system to detect repeat offenders or identify quickly individuals who are supposed to be in the spot.

The mobile device remotely communicates with the computing system to authenticate an individual who parks in the handicap spot as seen in FIG. 8. The mobile device comprises a mobile application. The mobile application utilizes the components on the mobile device such as a fingerprint scanner to obtain a fingerprint from the user. At this point the fingerprint is then cross verified with the fingerprint database. If the fingerprint does not match a fingerprint within the fingerprint database one of the plurality of lights turns red and the user is then towed away or ticketed. If the user in a place with bad service a key tag can be utilized similar to the mobile device which verifies the user is supposed to park in the handicap spot and communicates this information to the computing system to turn one of the plurality of lights green. With all the components working in tandem with each other it can be seen that thus, the present invention is a system that authorizes vehicles parked in handicap spots to ensure that only handicap individuals park within these handicap spots

Although the invention has been explained in relation to its preferred embodiment, it is to be understood that many other possible modifications and variations can be made without departing from the spirit and scope of the invention as hereinafter claimed.

What is claimed is:

1. A handicap parking spot authorization system comprising:
a plurality of lights;
an infrared sensor;
a solar panel;
a base;
a mobile device;
the plurality of lights comprising a red light, a amber light, and a green light;
the base comprising a computing system and a protective housing; and
the mobile device comprising a mobile application.

2. The handicap parking spot authorization system as claimed in claim 1 wherein the computing system further comprising a radio device, a centralized server, and a facial recognition module.

3. The handicap parking spot authorization system as claimed in claim 2 wherein the mobile device remotely communicates with the base.

4. The handicap parking spot authorization system as claimed in claim 1 wherein the plurality of lights change color.

5. The handicap parking spot authorization system as claimed in claim 1 wherein the plurality of lights, infrared sensor, solar panel, and base are electronically coupled to one another.
